(19) United States
(12) Patent Application Publication
(10) Pub. No.: US 2020/0296745 A1
(43) Pub. Date: Sep. 17, 2020

(54) APPARATUS AND METHOD FOR RESOURCE SCHEDULING RELATED TO DEVICE-TO-DEVICE COMMUNICATION

(71) Applicant: NEC CORPORATION, Tokyo (JP)

(72) Inventors: Masaki INOKUCHI, Tokyo (JP); Kazushi MURAOKA, Tokyo (JP)

(73) Assignee: NEC CORPORATION, Tokyo (JP)

(21) Appl. No.: 16/086,045

(22) PCT Filed: Jan. 12, 2017
(86) PCT No.: PCT/JP2017/000753

§ 371 Date: Sep. 18, 2018

(30) Foreign Application Priority Data
Mar. 23, 2016 (JP) 2016-058489

(51) Int. Cl. H04W 72/12

(52) U.S. Cl. CPC H04W 72/1268; H04W 72/121; H04W 88/04; H04W 72/1247; H04W 72/1252

(57) ABSTRACT

An apparatus (3) for uplink scheduling is configured to distinguish a plurality of uplink transmissions (120, 121, 122) related to a transfer of data originating from a first remote terminal (1A) from other uplink transmissions. The apparatus (3) further determines allocation of uplink radio resources at least partly based on whether the plurality of uplink transmissions (120, 121, 122) can be scheduled in the same transmission period. In this way, for example, it is possible to contribute to an improvement in performance of a plurality of uplink transmissions related to a transfer of data originating from one remote terminal.

### TECHNICAL FIELD

The present disclosure relates to inter-terminal direct communication (i.e., device-to-device (D2D) communication) and, in particular, to uplink resource scheduling suitable for D2D communication.

### BACKGROUND ART

A type of communication in which e a wireless terminal directly communicates with another wireless terminal without going through an infrastructure network such as a base station is called device-to-device (D2D) communication. The D2D communication includes at least one of Direct Communication and Direct Discovery. In some implementations, a plurality of wireless terminals supporting D2D communication form a D2D communication group autonomously or under the control of a network, and communicate with another wireless terminal in the formed D2D communication group.

Proximity-based services (ProSe) specified in 3GPP Release 12 is one example of the D2D communication. ProSe Direct Discovery is performed through a procedure in which a wireless terminal capable of performing ProSe (i.e., ProSe-enabled User Equipment (UE)) discovers another ProSe-enabled UE only by using the capability of a radio communication technology (e.g., Evolved Universal Terrestrial Radio Access (E-UTRA) technology) of those two UEs. ProSe Direct Discovery may be performed by three or more ProSe-enabled UEs.

ProSe Direct Communication enables establishment of a communication path between two or more ProSe-enabled UEs existing in a direct communication range after the ProSe Direct Discovery procedure is performed. Stated differently, ProSe Direct Communication enables a ProSe-enabled UE to directly communicate with another ProSe-enabled UE without going through a Public Land Mobile Network (PLMN)) including a base station (eNodeB (eNB)). ProSe Direct Communication may be performed by using a radio communication technology (i.e., E-UTRA technology) that is also used to access a base station (eNB) or by using a Wireless Local Area Network (WLAN) radio technology (i.e., IEEE 802.11 radio technology).

In 3GPP Release 12, a radio link between wireless terminals used for Direct Communication or Direct Discovery is referred to as a Sidelink. Sidelink transmission uses the Long Term Evolution (LTE) frame structure defined for uplink and downlink and uses a subset of uplink resources in frequency and time domains. A wireless terminal (i.e., UE) performs sidelink transmission by using Single Carrier FDMA (Frequency Division Multiple Access) (SC-FDMA), which is the same as used in uplink.

In 3GPP Release 12 ProSe, allocation of radio resources to a UE for sidelink transmission is performed by a radio access network (e.g., Evolved Universal Terrestrial Radio Access Network (E-UTRAN)). A UE that has been permitted to perform sidelink communication by a ProSe function performs ProSe Direct Discovery or ProSe Direct Communication by using radio resources allocated by a radio access network node (e.g., eNB (eNB)).

As for ProSe Direct Communication, two resource allocation modes, i.e., scheduled resource allocation and autonomous resource selection, are defined. The scheduled resource allocation and the autonomous resource selection are referred to as “sidelink transmission mode 1” and “sidelink transmission mode 2”, respectively.

In the scheduled resource allocation for ProSe Direct Communication, when a UE desires to perform sidelink transmission, this UE requests an eNB to allocate radio resources for sidelink transmission, and the eNB allocates resources for sidelink control and data to the UE. To be specific, a UE transmits to an eNB a scheduling request to request an uplink (UL) data transmission resource (i.e., Uplink Shared Channel (UL-SCH) resource) and then transmits a Sidelink Buffer Status Report (Sidelink BSR) to the eNB by using an UL data transmission resource allocated by an uplink grant (UL grant). The eNB determines sidelink transmission resources to be allocated to the UE based on the Sidelink BSR and transmits a sidelink grant (SL grant) to the UE.

The SL grant is defined as Downlink Control Information (DCI) format 5. The SL grant (i.e., DCI format 5) contains contents such as a Resource for PSCCH, Resource block assignment and hopping allocation, and a time resource pattern index. The Resource for PSCCH indicates radio resources for a sidelink control channel (i.e., Physical Sidelink Control Channel (PSCCH)). The Resource block assignment and hopping allocation is used to determine frequency resources, i.e., a set of subcarriers (resource blocks), for transmitting a sidelink data channel (i.e., Physical Sidelink Shared Channel (PSSCH)) for sidelink data transmission. The Time resource pattern index is used to determine time resources, i.e., a set of subframes, for transmitting the PSSCH. Note that, strictly speaking, the resource block means time-frequency resources in LTE and LTE-Advanced and is a unit of resources specified by consecutive OFDM (or SC-FDMA) symbols in the time domain and consecutive subcarriers in the frequency domain. In the case of Normal cyclic prefix, one resource block includes 12 consecutive OFDM (or SC-FDMA) symbols in the time domain and 12 subcarriers in the frequency domain. That is, the Resource block assignment and hopping allocation and the Time resource pattern index designate a resource block for transmitting the PSSCH. The UE (i.e., a sidelink transmission terminal) determines a PSCCH resource and a PSSCH resource according to the SL grant.

On the other hand, in the autonomous resource selection for ProSe Direct Communication, a UE autonomously selects resources for sidelink control (i.e., PSCCH) and data (i.e., PSSCH) from a resource pool(s) set by an eNB. The eNB may allocate a resource pool(s) for the autonomous resource selection to the UE in a System Information Block (SIB) 18. The eNB may allocate a resource pool for the autonomous resource selection to the UE in Radio Resource Control (RRC)_CONNECTED by dedicated RRC signaling. This resource pool may be usable also when the UE is in RRC_IDLE.

When direct transmission is performed on a sidelink, a UE on a transmitting side (i.e., a D2D transmitting UE) (hereinafter referred to as a transmitting terminal) transmits Scheduling Assignment information by using a portion of radio resources (i.e., resource pool) for a sidelink control channel (i.e., PSCCH). The scheduling assignment information is also referred to as Sidelink Control Information (SCI) format 0. The scheduling assignment information includes contents such as resource block assignment and hopping allocation, a time resource pattern index, and a Modulation and Coding Scheme (MCS). In the case of the above-described scheduled resource allocation, the Resource block assignment and hopping allocation and the time resource pattern index indicated by the Scheduling Assignment (i.e., SCI format 0) follow the Resource block assignment and hopping allocation and the time resource pattern index indicated by the SL grant (i.e., DCI format 5) received from the eNB.

The transmitting terminal transmits data on the PSSCH by using a radio resource according to the scheduling assignment information. A UE on a receiving side (i.e., a D2D receiving UE) (hereinafter referred to as a receiving terminal) receives the scheduling assignment information from the transmitting terminal on the PSCCH and receives the data on the PSSCH according to the received scheduling assignment information. Note that the term “transmitting terminal” just focuses on a transmission operation of a wireless terminal and does not mean a radio terminal dedicated for transmission. Similarly, the term “receiving terminal” is an expression for expressing a receiving operation of a wireless terminal and does not mean a wireless terminal dedicated for reception. That is, the transmitting terminal is able to perform a receiving operation and the receiving terminal is able to perform a transmitting operation.

3GPP Release 12 further defines a partial coverage scenario where one UE is located outside the network coverage and another UE is located within the network coverage. In the partial coverage scenario, the UE outside the coverage is referred to as a “remote UE” or a “sidelink remote UE”, and the UE that is in coverage and performs relaying between the remote UE and the network is referred to as a “ProSe UE-to-Network Relay” or a “sidelink relay UE”. The ProSe UE-to-Network Relay relays traffic (downlink and uplink) between the remote UE and the network (E-UTRA network (E-UTRAN) and EPC).

More specifically, the ProSe UE-to-Network Relay attaches to the network as a UE, establishes a PDN connection to communicate with a ProSe function entity or another Packet Data Network (PDN), and communicates with the ProSe function entity to start ProSe direct communication. The ProSe UE-to-Network Relay further performs the discovery procedure with the remote UE, communicates with the remote UE on the inter-UE direct interface (e.g., sidelink or PC5 interface), and relays traffic (downlink and uplink) between the remote UE and the network. When the Internet Protocol version 4 (IPv4) is used, the ProSe UE-to-Network Relay operates as a Dynamic Host Configuration Protocol Version 4 (DHCPv4) Server and Network Address Translation (NAT). When the IPv6 is used, the ProSe UE-to-Network Relay operates as a stateless DHCPv6 Relay Agent.

Further, 3GPP Release 13 includes extensions of ProSe (see, for example, Non-patent Literatures 1 to 3). Non-patent Literature 1 specifies a procedure for initiating Direct communication via ProSe UE-to-Network Relay and a procedure for initiating One-to-one ProSe Direct Communication (see Sections 5.4.4 and 5.4.5 of Non-Patent Literature 1). Non-patent Literature 2 specifies sidelink-related RRC procedures including one to one sidelink communication, a sidelink relay operation, and a sidelink remote operation (see Section 5 of Non-Patent Literature 2). Non-patent Literature 3 specifies a Medium Access Control (MAC) function for supporting one-to-one sidelink communication (or unicast sidelink communication) including communication between a sidelink remote UE and a sidelink relay UE (see Sections 5.4.4, 5.14, 6.1.3.1a and 6.2.1 of Non-Patent Literature 3).

In the specification, a radio terminal having the D2D communication capability and the relay capability, such as the ProSe UE-to-Network Relay (the sidelink relay UE), is referred to as a “relay terminal” or a “relay UE”. Further, a radio terminal that receives a relay service provided by a relay UE is referred to as a “remote terminal” or a “remote UE”. The remote terminal may also be referred to as a “relayed terminal”.

### CITATION LIST

### Non Patent Literature

Non-patent Literature 1: 3GPP TS 23.303 V13.2.0 (2015-12), “3rd Generation Partnership Project; Technical Specification Group Services and System Aspects; Proximity-based services (ProSe); Stage 2 (Release 13)”, December 2015

Non-patent Literature 2: 3GPP TS 36.331 V13.0.0 (2015-12), “3rd Generation Partnership Project; Technical Specification Group Radio Access Network; Evolved Universal Terrestrial Radio Access (E-UTRA); Radio Resource Control (RRC); Protocol specification (Release 13)”, December 2015

Non-patent Literature 3: 3GPP TS 36.321 V13.0.0 (2015-12), “3rd Generation Partnership Project; Technical Specification Group Radio Access Network; Evolved Universal Terrestrial Radio Access (E-UTRA); Medium Access Control (MAC) protocol specification (Release 13)”, December 2015

### SUMMARY OF INVENTION

### Technical Problem

The inventors have studied uplink scheduling suitable for cases where a remote terminal is connected to one or more relay terminals and data originating from this remote terminal is transferred to a base station through a plurality of uplink paths. The plurality of uplink paths may include at least two uplink transmissions from at least two relay terminals to the base station. Alternatively, the plurality of uplink paths may include at least one uplink transmission from at least one relay terminal to the base station and uplink transmission from the remote terminal itself to the base station. That is, the remote terminal may be located within a cellular coverage (i.e., cell) of the base station and perform cellular communication with the base station.

In uplink scheduling, in response to scheduling requests and Buffer Status Reports (BSRs) from a plurality of radio terminals, the base station schedules a plurality of uplink transmissions of these plurality of radio terminals. In general, a base station calculates a metric value for each radio terminal or for each uplink transmission based on a priority, fairness, communication efficiency, or the like, compares metric values of a plurality of radio terminals (or uplink transmissions), and allocates radio resources within the current transmission period (e.g., the current LTE subframe) to one or more radio terminals. Radio resources within one transmission period include, for example, frequency resources (e.g., LTE resource blocks) and transmission power resources. In some implementations, some radio terminals have a higher priority than other radio terminals and this priority is taken into consideration in uplink scheduling.

However, it should be noted that in a case where there are a plurality of uplink transmissions related to a transfer of data originating from one remote terminal, effective uplink performance (e.g., bandwidth, data rate, or throughput) of this remote terminal depends on the sum of the performances of these plurality of uplink transmissions. In ordinary uplink scheduling, a plurality of uplink transmissions related to a transfer of data originating from one remote terminal are not distinguished from other uplink transmissions. Therefore, ordinary uplink scheduling cannot handle these plurality of uplink transmissions separately from the others.

For example, ordinary uplink scheduling does not ensure that a plurality of uplink transmissions related to a data transfer of one remote terminal are scheduled in the same transmission period (e.g., the same subframe). It might be preferable that these plurality of uplink transmissions be scheduled in the same transmission period and be simultaneously performed as much as possible. When a larger number of frequency resources (or resource blocks) within one transmission period are allocated to one uplink transmission (or one radio terminal), transmission power per frequency resource (or per resource block) decreases, and thus a bit rate (or throughput) per frequency resource (or per resource block) decreases. In contrast, if a plurality of uplink transmissions performed by a plurality of radio terminals are scheduled in the same transmission period, the number of frequency resources (or resource blocks) allocated to each uplink transmission relatively decreases and hence transmission power per frequency resource (or per resource block) increases, which thereby allows a bit rate (or throughput) per frequency resource (or per resource block) to be increased.

One of the objects to be attained by embodiments disclosed herein is to provide an apparatus, a method, and a program that contribute to an improvement in performance of a plurality of uplink transmissions related to a transfer of data originating from one remote terminal. It should be noted that the above-described object is merely one of the objects to be attained by the embodiments disclosed herein. Other objects or problems and novel features will be made apparent from the following description and the accompanying drawings.

### Solution to Problem

In a first aspect, an apparatus for uplink scheduling includes a memory and at least one processor coupled to the memory. The at least one processor is configured to distinguish a plurality of uplink transmissions related to a transfer of data originating from a first remote terminal from other uplink transmissions. The at least one processor is further configured to determine allocation of uplink radio resources at least partly based on whether the plurality of uplink transmissions can be scheduled in the same transmission period. Note that the plurality of uplink transmissions are transmissions from a plurality of radio terminals including at least one relay terminal to a base station. Each relay terminal relays traffic between the first remote terminal and the base station through a device-to-device (D2D) link between the relay terminal and the first remote terminal and a backhaul link between the relay terminal and the base station.

In a second aspect, a method for uplink scheduling includes (a) distinguishing a plurality of uplink transmissions related to a transfer of data originating from a first remote terminal from other uplink transmissions, and (b) determining allocation of uplink radio resources at least partly based on whether the plurality of uplink transmissions can be scheduled in the same transmission period.

In a third aspect, a program includes a set of instructions (software codes) that, when loaded into a computer, causes the computer to perform a method according to the above-described second aspect.

### Advantageous Effects of Invention

According to the above-described aspects, it is possible to provide an apparatus, a method, and a program that contribute to an improvement in performance of a plurality of uplink transmissions related to a transfer of data originating from one remote terminal.

### BRIEF DESCRIPTION OF DRAWINGS

FIG. 1 shows a configuration example of a radio communication network according to a first embodiment;

FIG. 2 is a block diagram showing a configuration example of an uplink scheduler implemented in a base station according to the first embodiment;

FIG. 3 is a flowchart showing an example of an uplink scheduling procedure performed by the base station according to the first embodiment;

FIG. 4 is a diagram for explaining an outline of uplink scheduling according to the first embodiment;

FIG. 5A shows a comparative example of uplink scheduling;

FIG. 5B shows an example of uplink scheduling according to the first embodiment;

FIG. 6A shows a comparative example of uplink scheduling;

FIG. 6B shows an example of uplink scheduling according to the first embodiment;

FIG. 7A shows a comparative example of uplink scheduling;

FIG. 7B shows an example of uplink scheduling according to the first embodiment;

FIG. 8 is a sequence diagram showing an example of detection of a UE group according to the first embodiment;

FIG. 9 is a sequence diagram showing an example of detection of a UE group according to the first embodiment;

FIG. 10 is a sequence diagram showing an example of detection of a UE group according to the first embodiment;

FIG. 11 shows a configuration example of a radio communication network according to a second embodiment;

FIG. 12 is a flowchart showing an example of an uplink scheduling procedure performed by a base station according to the second embodiment;

FIG. 13 is a block diagram showing a configuration example of a radio terminal according to some embodiments; and

FIG. 14 is a block diagram showing a configuration example of a base station according to some embodiments.

### DESCRIPTION OF EMBODIMENTS

In the following, specific embodiments will be described in detail with reference to the drawings. The same or corresponding elements are denoted by the same symbols throughout the drawings, and duplicated explanations are omitted as necessary for the sake of clarity.

Each of the embodiments described below may be used individually, or two or more of the embodiments may be appropriately combined with one another. These embodiments include novel features different from each other. Accordingly, these embodiments contribute to attaining objects or solving problems different from one another and also contribute to obtaining advantages different from one another.

The following embodiments will be described on the assumption that they are implemented to 3GPP ProSe. However, these embodiments are not limited to the LTE-Advanced and its improvements and may also be applied to D2D communication in other mobile communication networks or systems.

### First Embodiment

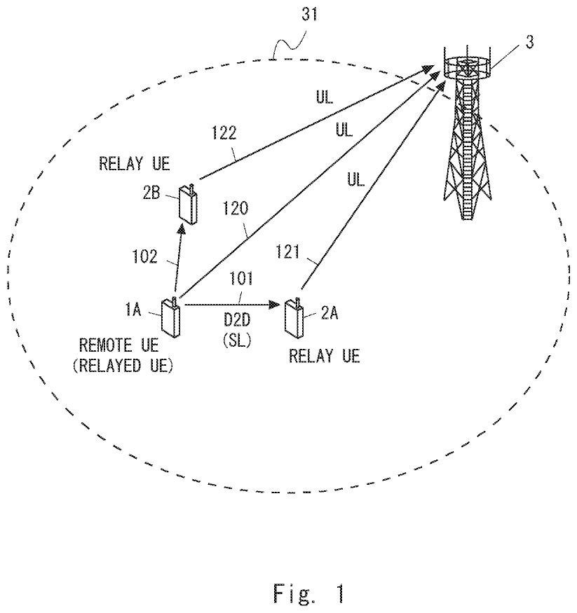

FIG. 1 shows a configuration example of a radio communication network according to this embodiment. Specifically, FIG. 1 shows an example related to a UE-to-Network Relay (i.e., sidelink relay UE) and shows a remote UE 1A, and a plurality of relay UEs 2A and 2B. In the following description, when matters common to a plurality of remote UEs including the remote UE 1A are described, they are simply referred to as the “remote UE 1” by using a reference numeral “1”. Similarly, when matters common to a plurality of relay UEs including the relay UEs 2A and 2B are described, they are simply referred to as the “relay UE 2” by using a reference numeral “2”.

The remote UE 1 includes at least one radio transceiver and is configured to perform D2D communication with one or more relay UEs 2 on one or more D2D links (e.g., D2D link 101). As already described, the D2D link is referred to as a PC5 interface or a sidelink in the 3GPP. The D2D communication includes at least direct communication (i.e., ProSe Direct Communication) and may further include direct discovery (i.e., ProSe Direct Discovery). The ProSe Direct Communication is direct communication using sidelink transmission and is also referred to as Sidelink Direct Communication. Similarly, the ProSe Direct Discovery is direct discovery using sidelink transmission and is also referred to as Sidelink Direct Discovery. Further, the remote UE 1 is configured to perform cellular communication through a cellular link (e.g., cellular link 120) including an uplink and a downlink between the remote UE 1 and a base station (i.e., eNB) 3 in a cellular coverage (i.e., cell) 31 provided by the base station 3.

The relay UE 2 includes at least one radio transceiver and is configured to perform cellular communication with the base station 3 on a cellular link including an uplink and a downlink (e.g., cellular link 121) in the cellular coverage 31 and perform D2D communication (e.g., ProSe direct discovery and ProSe direct communication) with the remote UE 1 on a D2D link (e.g., D2D link 101).

The base station 3 is an entity disposed in a radio access network (i.e., E-UTRAN), provides the cellular coverage 31 including one or more cells, and is able to communicate with the relay UE 2 on a cellular link (e.g., cellular link 121) by using a cellular communication technology (e.g., E-UTRA technology). Further, the base station 3 is configured to perform cellular communication with the remote UE 1 when it is located within the cellular coverage 31.

FIG. 1 shows one relay scenario. Specifically, one remote UE 1A is connected to a plurality of relay UEs 2A and 2B. The remote UE 1A transmits data on two D2D links 101 and 102, and the relay UEs 2A and 2B transmit the data received from the remote UE 1A to the base station 3 on cellular links 121 and 122 (i.e., uplinks). Further, the remote UE 1A can transmit data to the base station 3 on a direct cellular link 120 (i.e., uplink) between the remote UE 1A itself and the base station 3. The relay scenario shown in FIG. 1 is merely an example and various relay scenarios can be used. For example, in one relay scenario, one remote UE 1 may be connected to one relay UE 2 and this remote UE 1 may use two uplink transmissions, i.e., uplink transmission of the relay UE 2 and its own uplink transmission. In another relay scenario, two remote UEs 1 may be connected to one relay UE 2 and each relay UE 2 may use two uplink transmissions, i.e., uplink transmission of the relay UE 2 and its own uplink transmission.

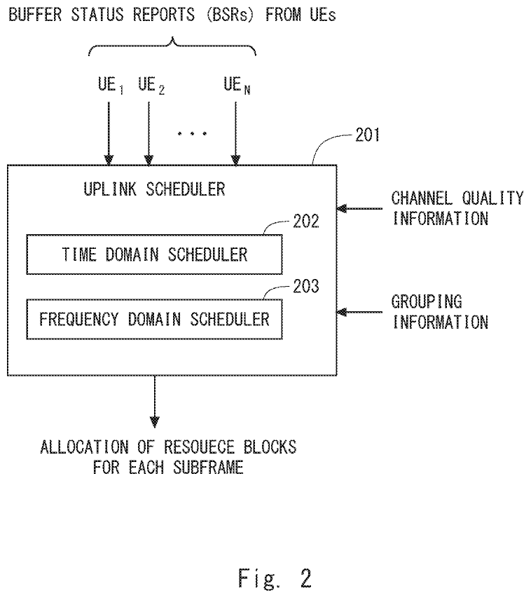

Next, uplink scheduling performed by the base station 3 is described. FIG. 2 shows a configuration example of an uplink scheduler implemented in the base station 3. The uplink scheduler 201 shown in FIG. 2 schedules uplink transmissions of a plurality of UEs based on BSRs from these UEs. Specifically, the uplink scheduler 201 determines allocation of a plurality of frequency resources (i.e., resource blocks) within one subframe (i.e., one transmission period) to the plurality of UEs or a subset thereof. Note that the radio resources within a transmission period may be different radio resources other than frequency resources, or a combination of frequency resources and other radio resources. That is, the radio resources within a transmission period are dependent on a radio communication technology adopted for the uplink. For example, the radio resources in a transmission period may include spread code resources, or transmission power resources, or both.

The uplink scheduler 201 considers channel quality information in the uplink scheduling. The channel quality information indicates channel quality of a plurality of resource blocks between each UE and the base station 3. The uplink scheduler 201 may consider other information and constrains in the uplink scheduling. For example, the uplink scheduler 201 may take account of the maximum uplink transmission power of each UE, a Quality of Service (QoS) requirement of each UE (e.g., Guaranteed Bit Rate (GBR)), a history of the transmission rate of each UE, or a priority of each UE, or any combination thereof.

Further, the uplink scheduler 201 considers grouping information in the uplink scheduling. The grouping information indicates association between one remote UE 1 and one or more relay UEs 2 related to data transmission of this remote UE 1. Alternatively, the grouping information indicates association between a plurality of uplink transmissions related to data originating from one remote UE 1. The plurality of uplink transmissions are transmissions from a plurality of UEs including at least one relay UE 2 to the base station 3. Accordingly, the grouping information can also be referred to as association information. For example, the grouping information includes information for identifying one or more relay UEs 2 to which each remote UE 1 is connected.

In some implementations, the grouping information may associate an identifier of each remote UE 1 with an identifier(s) of one or more relay UEs 2 to which this remote UE 1 is connected. Alternatively, the grouping information may associate an identifier of each relay UE 2 with an identifier(s) of one or more remote UEs 1 connected to this relay UE 2. Alternatively, the grouping information may associate an identifier of a UE group with identifiers of a plurality of UEs belonging to this UE group. Note that the UE group includes one remote UE 1 and one or more relay UEs 2 related to a transfer of data of this remote UE 1.

In some implementations, the uplink scheduler 201 may include a time-domain scheduler 202 and a frequency-domain scheduler 203 as shown in FIG. 2. The time-domain scheduler 202 prioritizes a plurality of UEs and selects UEs to be scheduled in each transmission period (i.e., each subframe). The frequency-domain scheduler 203 determines optimal mapping between resource blocks in each transmission period (i.e., each subframe) and UEs selected by the time-domain scheduler 202.

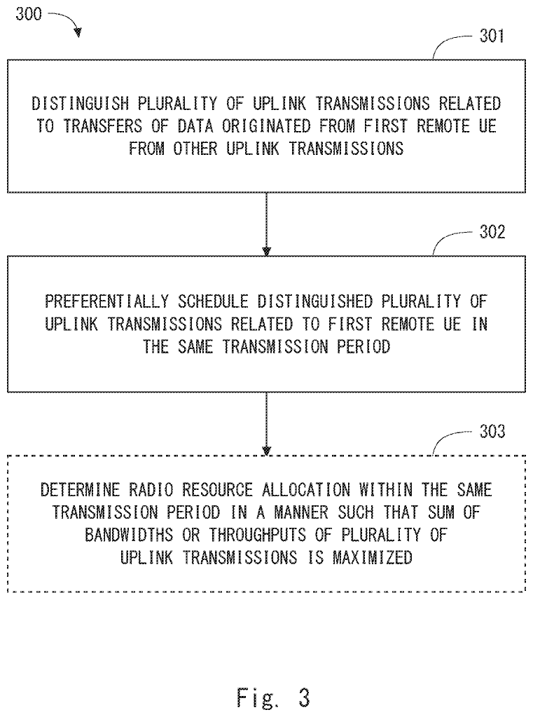

FIG. 3 shows a process 300 that is an example of an uplink scheduling procedure performed by the base station 3 according to this embodiment. In Step 301, the base station 3 (i.e., the uplink scheduler 201) distinguishes a plurality of uplink transmissions related to a transfer of data originating from a specific remote UE 1 (hereinafter referred to as a “first remote UE”) from other uplink transmissions. The plurality of uplink transmissions are transmissions from a plurality of UEs including at least one relay UE 2 to the base station 3. The plurality of uplink transmissions may include direct uplink transmission from the first remote UE to the base station 3.

In Step 302, the base station 3 (i.e., the uplink scheduler 201) determines allocation of uplink radio resources at least partly based on whether the plurality of uplink transmissions related to the first remote UE can be scheduled in the same transmission period (i.e., the same subframe). In some implementations, the base station 3 may determine allocation of uplink radio resources in a manner such that the plurality of uplink transmissions related to the first remote UE are simultaneously performed in the same transmission period as much as possible. In other words, as shown in FIG. 3, the base station 3 may preferentially schedule the plurality of uplink transmissions related to the first remote UE in the same transmission period. That is, the uplink scheduler 201 collectively handles the plurality of uplink transmissions related to the first remote UE in the uplink time-domain scheduling.

For example, the time-domain scheduler 202 included in the uplink scheduler 201 may select the uplink transmissions related to the first remote UE, or a group of UEs that perform these uplink transmissions (e.g., the first remote UE and one or more relay UEs 2) to schedule them in the current transmission period. Then, the frequency-domain scheduler 203 included in the uplink scheduler 201 may allocate resource blocks within the current transmission period to the UE group related to the first remote UE selected by the time-domain scheduler 202.

The process in Step 302 provides the following advantageous effect. That is, the process in Step 302 makes it possible to preferentially schedule the uplink transmissions related to the first remote UE in the same transmission period. As already described, in the case where one remote UE 1 can use a plurality of uplink paths, effective uplink performance (e.g., bandwidth, data rate, or throughput) of this remote UE 1 depends on the sum of the performances of these uplink transmissions. If the uplink transmissions related to the first remote UE are scheduled in the same transmission period, the number of resource blocks allocated to each uplink transmission relatively decreases and hence transmission power per frequency resource (or per resource block) increases, which thereby allows a bit rate (or throughput) per frequency resource (or per resource block) to be increased. Therefore, the base station 3 schedules these uplink transmissions in a manner such that they are simultaneously performed as much as possible, which thereby enhances the effective uplink performance of the first remote UE achieved by using these uplink paths.

Further, the base station 3 (i.e., the uplink scheduler 201) may perform a process in Step 303 of FIG. 3 in order to enhance the effective uplink performance of the first remote UE. In Step 303, the base station 3 (i.e., the uplink scheduler 201) determines radio resource allocation within the current transmission period in a manner such that the sum of bandwidths or throughputs of the uplink transmissions related to the first remote UE is maximized. In some implementations, the uplink scheduler 201 uses the existing capacity-maximizing resource allocation. Specifically, the uplink scheduler 201 may determine allocation of resource blocks to each UE in the UE group so as to maximize the sum of capacity-related metrics of all the UEs in the UE group under physical constraints (e.g., transmission power) and QoS-related constraints. An example of the capacity-related metrics is a throughput or a transmission rate of each UE.

Note that the uplink scheduler 201 does not need to consider fairness of resource allocation among the uplink transmissions related to data transmission of the first remote UE. For example, even if the throughput of the first remote UE is lowered, it is acceptable as long as the overall throughput of the UE group is increased owing to a high throughput(s) of one or more relay UEs 2.

The process in Step 303 provides the following advantageous effect. That is, the process in Step 303 makes it possible to maximize the overall communication capacity of the plurality of uplink transmissions related to the first remote UE in the current transmission period (e.g., the current subframe) without depending on the fairness among these plurality of uplink transmissions. Therefore, it is possible to even further enhance the effective uplink performance of the first remote UE achieved by using the plurality of uplink paths.

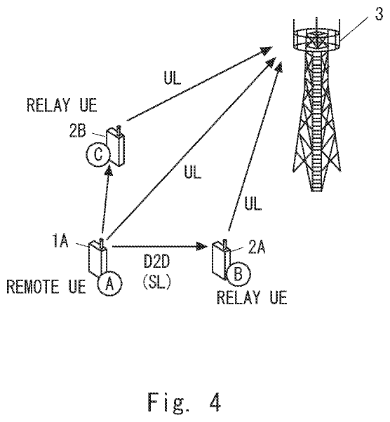

The following provides several specific examples of radio resource allocation based on the uplink scheduling according to this embodiment while comparing them with comparative examples. FIG. 4 shows a network model which will be referred to in the following description. The relay scenario shown in FIG. 4 is identical to that shown in FIG. 1. That is, three uplink transmissions performed by the remote UE 1A, the relay UE 2A, and the relay UE 2B are used for transmission of data of one remote UE 1A. In the following description, the remote UE 1A, the relay UE 2A, and the relay UE 2B are referred to as “UE-A”, “UE-B”, and “UE-C”, respectively, for the sake of convenience.

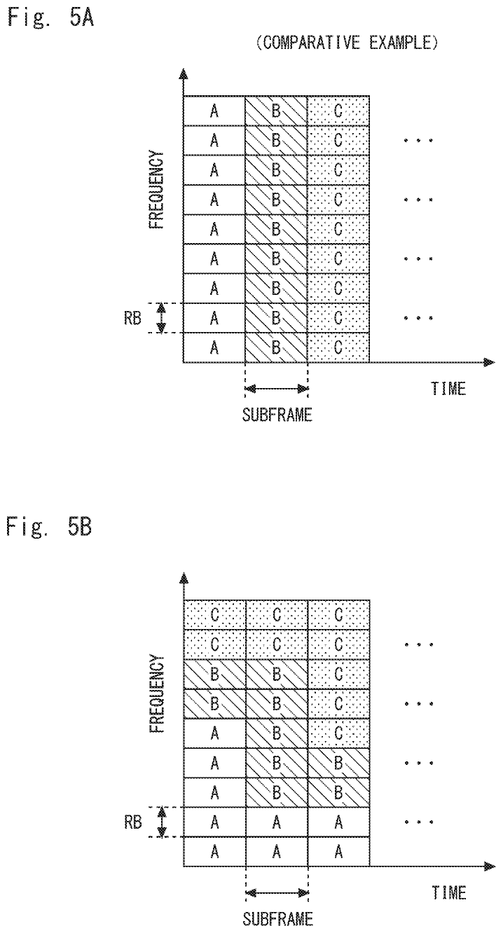

FIG. 5A shows a comparative example of radio resource allocation obtained by ordinary uplink scheduling. In the example shown in FIG. 5A, the UE-A (i.e., remote UE 1A), the UE-B (i.e., relay UE 2A), and the UE-C (i.e., relay UE 2B) are scheduled in different transmission periods (i.e., subframes) from one another. In the example shown in FIG. 5A, since a relatively large number of resource blocks (RBs) are allocated to one UE in one subframe, transmission power per resource block decreases and hence a transmission rate per resource block decreases.

In contrast to this, FIG. 5B shows an example of radio resource allocation obtained by the uplink scheduling according to this embodiment. In the example shown in FIG. 5B, the UE-A, the UE-B, and the UE-C, all of which are related to data transmission of the UE-A, are scheduled in each of the subframes. In other words, the uplink transmissions related to the UE-A (i.e., remote UE 1A) are preferentially scheduled in one subframe. In the example shown in FIG. 5B, since a relatively small number of resource blocks (RBs) are allocated to each UE in one subframe, transmission power per resource block increases, and hence a transmission rate per resource block increases. Therefore, compared to the radio resource allocation shown in FIG. 5A, the radio resource allocation shown in FIG. 5B can contribute to an enhancement of the effective uplink performance of the UE-A (i.e., remote UE 1A) achieved by using the plurality of uplink paths.

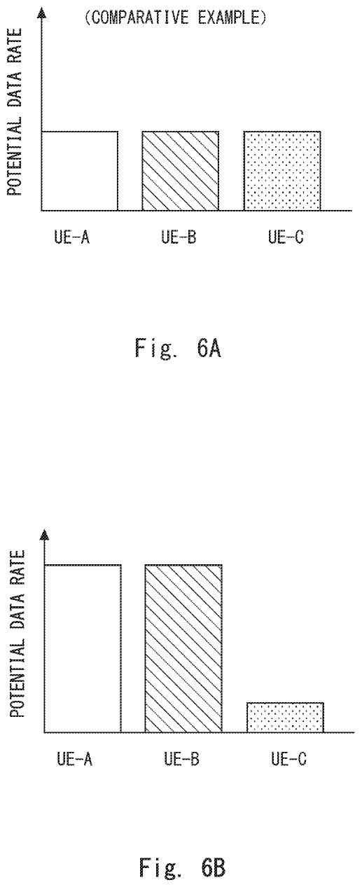

FIG. 6A shows an example of potential transmission rates that are obtained by considering fairness among the UE-A (i.e., remote UE 1A), the UE-B (i.e., relay UE 2A), and the UE-C (i.e., relay UE 2B). Specifically, in the example shown in FIG. 6A, the three UEs are given the same transmission rate by fairness-based scheduling. However, for example, when the uplink channel quality of the UE-C is lower than those of the UE-A and the UE-B, a large number of resource blocks are required to increase the transmission rate of the UE-C. As a result, the number of resource blocks allocated to the UE-A and the UE-B decreases. As already described, there is a possibility that taking account of fairness among a plurality uplink transmissions of UEs related to data transmission of one remote UE 1 could be undesirable. This is because the effective uplink performance (e.g., bandwidth, data rate, or throughput) of the remote UE 1 depends on the sum of performances of these uplink transmissions.

In contrast to this, FIG. 6B shows an example of transmission rates obtained by the uplink scheduling according to this embodiment. That is, the base station 3 allocates resource blocks in one subframe in a manner such that the sum of transmission rates of the UE-A, the UE-B, and the UE-C is maximized, without considering fairness among these three UEs. When the uplink channel quality of the UE-C is lower than those of the UE-A and the UE-B, the transmission rate of the UE-C decreases while the transmission rates of the UE-A and the UE-B increase as shown in FIG. 6B.

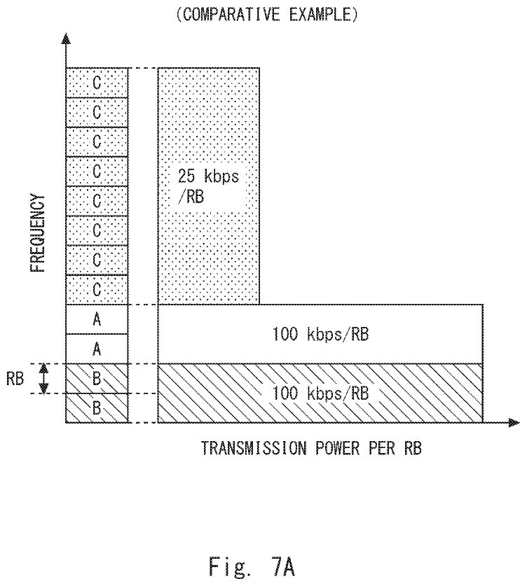

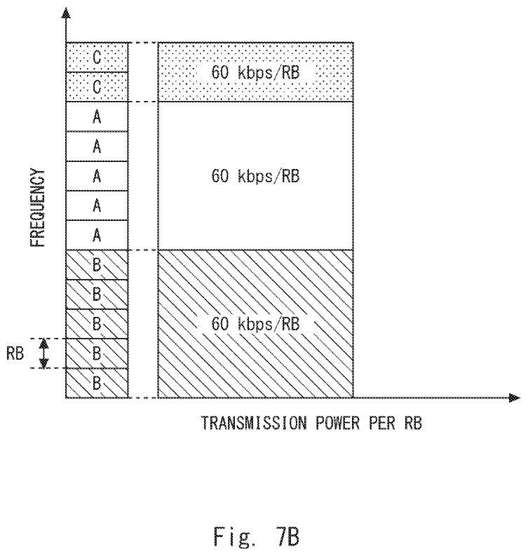

FIGS. 7A and 7B show examples of resource block allocation within one subframe to give the transmission rates shown in FIGS. 6A and 6B to the UE-A, the UE-B, and the UE-C. In these examples, a case where the uplink channel quality of the UE-C is lower than those of the UE-A and the UE-B is assumed.

In the example shown in FIG. 7A, fairness among the three UEs is considered to be important and hence the three UEs are made to have the same transmission rate of 200 kbit/s. However, since the uplink channel quality of the UE-C is low, a number of resource blocks (RBs) are required to increase the transmission rate of the UE-C. As a result, the overall transmission capacity of 12 resource blocks or the three UEs shown in FIG. 7A is 600 kbit/s.

In contrast to this, in FIG. 7B, fairness among the UE-A, the UE-B, and the UE-C is not taken into consideration, and 12 resource blocks within one subframe are allocated to these three UEs so as to maximize the overall transmission capacity of these three UEs. Specifically, a large number of resource blocks are allocated to each of the UE-A and the UE-B having relatively high uplink channel quality and a small number of resource blocks are allocated to the UE-C having relatively low uplink channel quality. As a result, the overall transmission capacity of 12 resource blocks or the three UEs shown in FIG. 7B is 720 kbit/s.

The following provides several specific examples of a method for detecting association between the remote UE 1 and the relay UE 2 in the base station 3. In some implementations, the base station 3 may receive, from the remote UE 1, first control information containing an identifier(s) of at least one relay UE 2 to which this remote UE 1 is connected, and then detect an association between the remote UE 1 and the relay UE 2 based on this first control information. The identifier of the relay UE 2 may include, for example, a ProSe Relay UE ID, a Cell Radio Network Temporary Identifier (C-RNTI), or a Sidelink RNTI (SL-RNTI). In this way, the base station 3 can detect a UE group related to data transmission of the remote UE 1. The UE group includes the remote UE 1 and at least one relay UE 2 connected to this remote UE 1.

The first control information may be an “SL-DestinationInfoListUC” information element in a Sidelink UE information message. The Sidelink UE information message is an RRC message that is transmitted from a UE to an E-UTRAN (or an eNB). For example, the UE transmits the Sidelink UE information message to inform the E-UTRAN that the UE is interested in a sidelink or is no longer interested therein. Further, the UE transmits the Sidelink UE information message to request an assignment or a release of transmission resources for sidelink communication or for a discovery announcement. The SL-DestinationlnfoListUC information element contained in the Sidelink UE information message indicates a destination of unicast sidelink transmission. The unicast destination is specified by a Layer-2 ID for unicast or a ProSe Relay UE ID.

Alternatively, the first control information may be a “Destination Index” field in a Sidelink BSR MAC Control Element (CE). The Sidelink BSR MAC CE is transmitted from a UE to an E-UTRAN (or an eNB) to inform the E-UTRAN about how much pending data is in a sidelink transmission buffer of the UE. The Destination Index field contained in the Sidelink BSR MAC CE specifies a destination of ProSe direct communication (i.e., sidelink communication). In the case of one-to-many ProSe Direct Communication (i.e., one-to-many sidelink communication), the Destination Index field indicates a ProSe Layer-2 Group ID. Meanwhile, in the case of one-to-one ProSe Direct Communication (i.e., unicast sidelink communication), the Destination Index field indicates a Layer-2 ID for unicast or a ProSe Relay UE ID. The One-to-one ProSe Direct Communication (i.e., unicast sidelink communication) includes unicast sidelink communication between the remote UE and the relay UE.

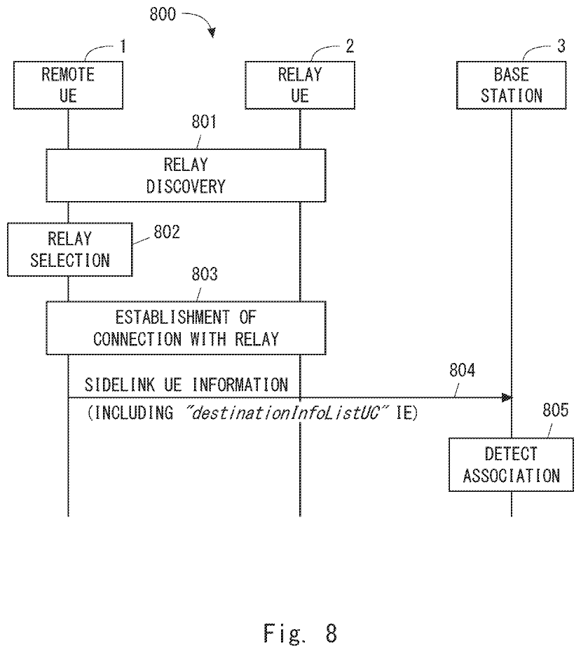

FIG. 8 is a sequence diagram showing a process 800 that is an example of UE group detection performed by the base station 3. In the example shown in FIG. 8, the remote UE 1 performs a relay selection. The relay selection performed by the remote UE 1 is referred to as a “distributed relay selection”. In Step 801, the remote UE 1 and the relay UE 2 perform a relay discovery procedure, so that the remote UE 1 discovers the relay UE 2. For example, in accordance with the so-called announcement model (i.e., model A), the relay UE 2 may transmit a discovery signal and the remote UE 1 may find the relay UE 2 by detecting the discovery signal transmitted from the relay UE 2. Alternatively, in accordance with the so-called solicitation/response model (i.e., model B), the remote UE 1 may transmit a discovery signal indicating that it desires a relay and the relay UE 2 may transmit a response message to this discovery signal to the UE 1, and then the remote UE 1 may find the relay UE 2 by receiving the response message transmitted from the relay UE 2.

In Step 802, the remote UE 1 selects at least one suitable relay UE 2 from one or more relay UEs 2 found in Step 801. In Step 803, the remote UE 1 establishes a connection for one-to-one ProSe Direct communication (i.e., unicast sidelink communication) with any one of the at least one selected relay UE 2. For example, the remote UE 1 may transmit a direct communication request (or a relay request) to the relay UE 2. Upon receiving the direct communication request (or the relay request), the relay UE 2 may start a procedure for mutual authentication.

In Step 804, the remote UE 1 transmits a Sidelink UE information message to the base station 3. This Sidelink UE information message indicates an identifier (e.g., a ProSe Relay UE ID) of the relay UE 2 to which the remote UE 1 has been connected in Step 803. In Step 805, upon receiving the Sidelink UE information message, the base station 3 detects an association between the remote UE 1 and the relay UE 2.

Alternatively, in some implementations, the base station 3 may receive, from the relay UE 2, second control information containing an identifier(s) of one or more remote UEs 1 connected to the relay UE 2, and then detect an association between the remote UE 1 and the relay UE 2 based on this second control information. The identifier of the remote UE 1 may include, for example, a Layer-2 ID for unicast, a Cell Radio Network Temporary Identifier (C-RNTI), or a Sidelink RNTI (SL-RNTI). In this way, the base station 3 can recognize one or more relay UEs 2 related to data transmission of one remote UE 1.

Similarly to the above-described first control information, the second control information may be an “SL-DestinationInfoListUC” information element in a Sidelink UE information message or a “Destination Index” field in a Sidelink BSR MAC Control Element (CE). In such cases, the identifier of the remote UE 1 may be a Layer-2 ID for unicast.

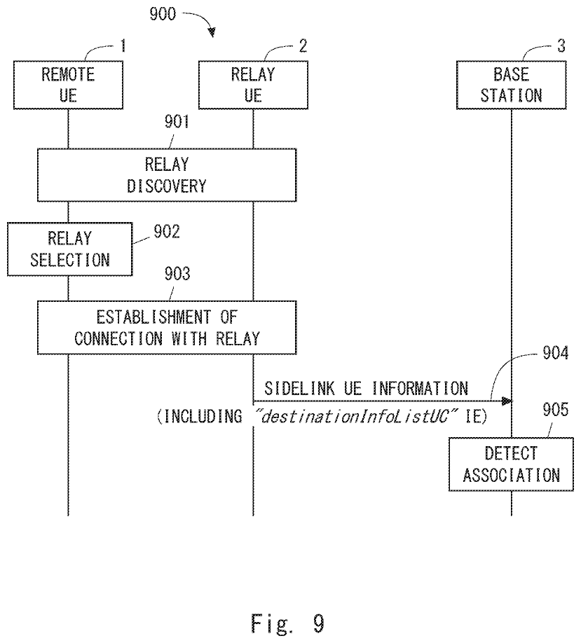

FIG. 9 is a sequence diagram showing a process 900 that is an example of UE group detection performed by the base station 3. In the example shown in FIG. 9, the remote UE 1 performs a relay selection. Processes in steps 901 to 903 are similar to those in Steps 801 to 803 in FIG. 8. In Step 904, the relay UE 2 transmits a Sidelink UE information message to the base station 3. This Sidelink UE information message indicates an identifier (e.g., a ProSe Relay UE ID) of the remote UE 1 to which the relay UE 2 has been connected in Step 903. In Step 905, upon receiving the Sidelink UE information message, the base station 3 detects an association between the remote UE 1 and the relay UE 2.

Alternatively, in some implementations, the base station 3 may receive third control information including a group identifier from each remote UE 1 and each relay UE 2, and then detect an association between the remote UE 1 and the relay UE 2 or detect a UE group based on this third control information. The group identifier is associated in a one-to-one manner with a UE group consisting of a plurality of UEs related to data transmission of one remote UE 1. For example, the group identifier may be determined by the remote UE 1 and reported from the remote UE 1 to the relay UE 2. Alternatively, the group identifier may be reported from a ProSe function entity or another control entity (e.g., a Mobility Management Entity (MME)) to each remote UE 1 and each relay UE 2.

Alternatively, in some implementations, the base station 3 may autonomously detect an association between the remote UE 1 and the relay UE 2. Specifically, the base station 3 may perform a relay selection for each remote UE 1. The relay selection performed by an entity in a network such as the base station 3 is referred to as a “centralized relay selection”. In this case, the base station 3 can fully recognize association between the remote UE 1 and the relay UE 2 though the relay selection.

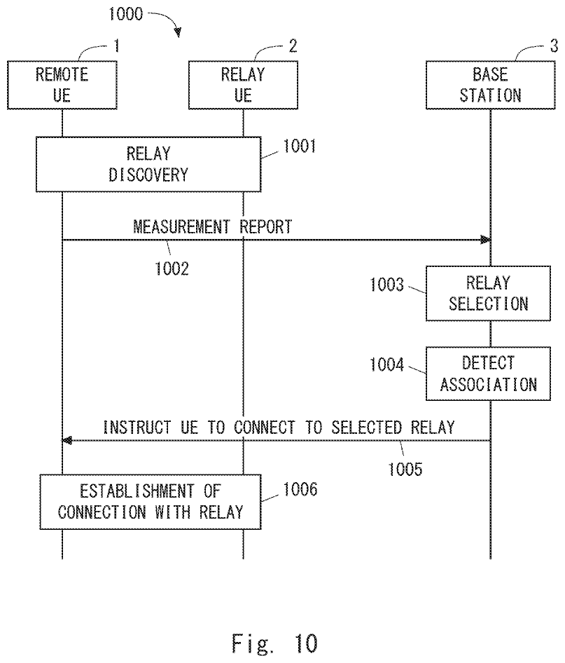

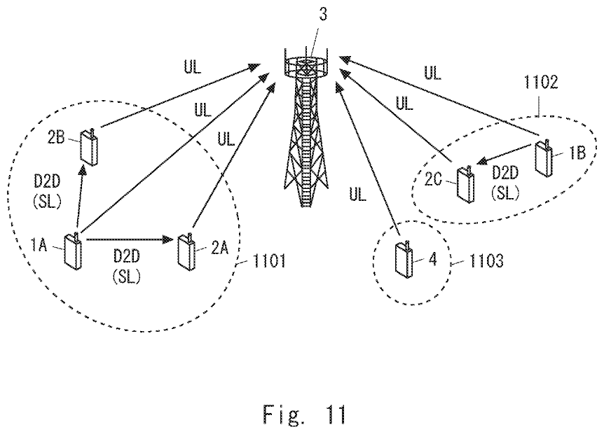

FIG. 10 is a sequence diagram showing a process 1000 that is an example of UE group detection performed by the base station 3. In the example shown in FIG. 10, the base station 3 performs a relay selection. In Step 1001, similarly to Step 801 in FIG. 8, the remote UE 1 and the relay UE 2 perform a relay discovery procedure, so that the remote UE 1 discovers the relay UE 2.

In Step 1002, the remote UE 1 transmits a measurement report to the base station 3. The measurement report is related to the one or more relay UEs 2 found in Step 1001 and includes, for example, sidelink quality. The sidelink quality may include, for example, at least one of received power, signal-to-interference plus noise ratio (SINR), and data rate (or throughput). Similarly to the existing measurement report, the measurement report may include cellular link quality between the remote UE 1 and the base station 3. Further, the measurement report may include backhaul link quality (between the base station 3 and the relay UE 2).

In Step 1003, the base station 3 selects at least one suitable relay UE 2 from one or more relay UEs 2 found by the remote UE 1. In Step 1004, the base station 3 detects (or records) an association between the remote UE 1 and the relay UE 2 based on a result of the relay selection in Step 1003.

In Step 1005, the base station 3 instructs the remote UE 1 to connect to the selected relay UE 2. In Step 1006, the remote UE 1 establishes a connection for one-to-one ProSe Direct communication (i.e., unicast sidelink communication) with a specific relay UE according to an instruction from the base station 3.

In this embodiment, a plurality of data streams originating from the remote UE 1 may be distinguished based on an application type, a priority, a requested QoS level, or the like. In this case, the remote UE 1 may be configured to transmit a plurality of data streams through different uplink paths. Additionally or alternatively, the remote UE 1 may use a different number of uplink paths for a plurality of data streams. Accordingly, the above-described association between the remote UE 1 and the relay UE 2 related to uplink transmission may be an association between uplink logical channels or an association between uplink bearers, instead of between UEs. That is, the base station 3 may detect the remote UE 1 and one or more relay UEs 2 connected to this remote UE 1, and associate a specific uplink logical channel (or bearer) of the remote UE 1 with one or more uplink logical channels (or bearers) of all or a subset of one or more relay UEs 2.

### Second Embodiment

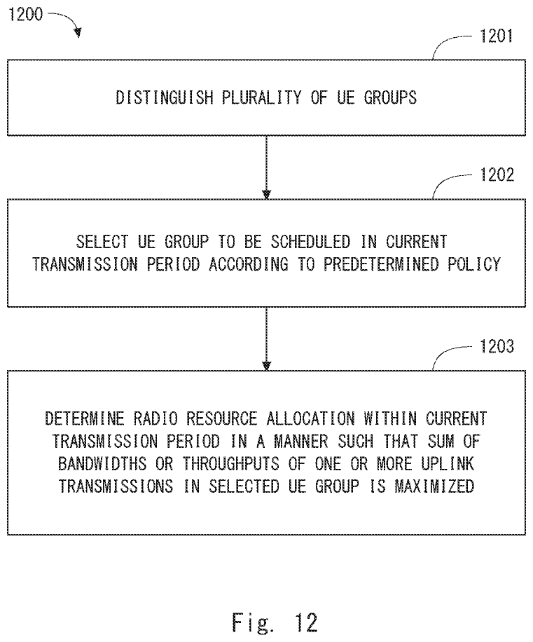

This embodiment provides a modified example of the uplink scheduling described in the first embodiment. FIG. 11 shows a configuration example of a radio communication network according to this embodiment. FIG. 11 shows a remote UE 1B, a relay UE 2C, and a UE 4 in addition to the remote UE 1A, the relay UEs 2A and 2B, and the base station 3 shown in FIG. 1.

In the example shown in FIG. 11, the remote UE 1A is connected to two relay UEs 2A and 2B. Accordingly, data originating from the remote UE 1A can be transmitted to the base station 3 through three uplink transmissions, i.e., uplink transmissions of the remote UE 1A, the relay UE 2A, and the relay UE 2B. The remote UE 1B is connected to one relay UE 2C. Thus, data originating from the remote UE 1B can be transmitted to the base station 3 through two uplink transmissions, i.e., uplink transmissions of the remote UE 1B and the relay UE 2C. Meanwhile, the UE 4 is connected to neither the remote UE 1 nor the relay UE 2, and performs only its own uplink transmission. Therefore, data originating from the UE 4 can be transmitted to the base station 3 through one uplink transmission of the UE 4 itself.

That is, the numbers of effective uplink transmissions (or uplink paths) of the remote UE 1A, the remote UE 1B, and the UE 4 shown in FIG. 11 are three, two, and one, respectively. In a situation where there are UEs having different numbers of available effective uplink transmissions as described above, it is preferable to give special consideration in the uplink scheduling.

The base station 3 according to this embodiment distinguishes UE groups from each other, and performs scheduling among these UE groups and scheduling within each UE group. Note that each UE group consists of one or more UEs related to transmission of data originating from one UE (i.e., the remote UE 1 or the UE 4). For example, the example shown in FIG. 11 illustrates three UE groups 1101, 1102 and 1103. The UE group 1101 consists of the remote UE 1A and the relay UEs 2A and 2B related to transmission of data originating from the remote UE 1A. The UE group 1102 consists of the remote UE 1B and the relay UE 2C related to transmission of data originating from the remote UE 1B. The UE group 1103 consists of the UE 4 related to transmission of data originating from the UE 4 itself.

The scheduling among UE groups includes selecting a UE group(s) to be scheduled in the current transmission period (i.e., the current subframe) from the plurality of UE groups according to a predetermined policy (i.e., time-domain scheduling). The predetermined policy includes considering fairness of radio resource allocation among the plurality of UE groups. The proportional fair (PF) scheduling may be used to consider fairness of radio resource allocation. Specifically, the base station 3 (i.e., the uplink scheduler 201 or the time-domain scheduler 202) may calculate an instantaneous throughput of each UE group in the current subframe, calculate an average throughput of each UE group in the past, and calculate a PF metric of each UE group based on both the instantaneous throughput and the past average throughput of this UE group. Further, the base station 3 may select one or more UE groups to be scheduled in the current subframe by comparing the calculated PF metrics of the plurality of UE groups. The instantaneous throughput of each UE group may be the sum of instantaneous throughputs of one or more UEs belonging to this UE group. The past average throughput of each UE group may be the sum of past average throughputs of one or more UEs belonging to this UE group.

Meanwhile, the scheduling within a UE group includes allocating radio resources (i.e., resource blocks) within one subframe to one or more UEs belonging to one UE group. The scheduling within a UE group is similar to the uplink scheduling described in the first embodiment. That is, in the scheduling within a UE group, the base station 3 (i.e., the uplink scheduler 201 or the frequency-domain scheduler 203) determines radio resource allocation according to a strategy of maximizing the overall communication capacity of one or more UEs (or one or more uplink transmissions) in one UE group in the current subframe without depending on fairness among these one or more UEs (or these one or more uplink transmissions).

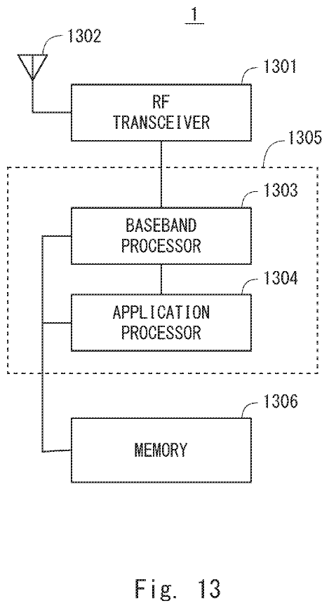

FIG. 12 shows a process 1200 that is an example of an uplink scheduling procedure performed by the base station 3 according to this embodiment. In Step 1201, the base station 3 (i.e., the uplink scheduler 201) distinguishes a plurality of UE groups from each other. Each UE group consists of one or more UEs that perform one or more uplink transmissions related to one UE (i.e., the remote UE 1 or the UE 4).

In Step 1202, the base station 3 (i.e., the uplink scheduler 201) selects one or more UE groups to be scheduled in the current transmission period (i.e., the current subframe) according to a predetermined policy. As described above, the base station 3 considers fairness of radio resource allocation among a plurality of UE groups by using, for example, the proportional fair (PF) strategy.

In Step 1203, the base station 3 (i.e., the uplink scheduler 201) determines radio resource allocation within the current transmission period in a manner such that the sum of bandwidths or throughputs of one or more uplink transmissions in the selected UE group is maximized.

As understood from the above description, in this embodiment, the base station 3 performs scheduling among UE groups while considering fairness of radio resource allocation among the UE groups. In principle, it is preferable that a UE group with a small number of uplink transmissions be prioritized in radio resource allocation over a UE group with a large number of uplink transmissions. This is because a data-originating UE (i.e., the remote UE 1) in a UE group with a large number of uplink transmissions can have a larger number of practical transmission opportunities and hence can practically use a larger number of uplink radio resources. The scheduling among UE groups according to this embodiment can contribute to avoiding unfairness due to a difference in the number of uplink transmissions (or uplink paths) among a plurality of UE groups.

In the above-described scheduling among UE groups, a priority level based on the number of uplink transmissions (or uplink paths) of each UE group may be directly taken into consideration. Specifically, a higher priority level is assigned to a UE group with a small number of uplink transmissions than that assigned to a UE group with a larger number of uplink transmissions. That is, the priority level is defined so that it changes inversely to the number of UEs or the number of uplink transmissions in a UE group. The base station 3 determines whether a specific UE group should be preferentially scheduled in a specific transmission period over other UE groups based on the aforementioned priority level. In this way, it is possible to directly contribute to avoiding unfairness due to a difference in the number of uplink transmissions (or uplink paths) among a plurality of UE groups.

Further, in frequency-domain scheduling for allocating radio resources (i.e., resource blocks) within one transmission period (i.e., one subframe) to a plurality of UE groups, a priority level based on the number of uplink transmissions (or uplink paths) of each UE group may also be directly taken into consideration. That is, when the base station 3 (i.e., the uplink scheduler 201) allocates uplink radio resources within a given transmission period, it may determine whether to prioritize a specific UE group over other UE groups at least partly based on the number of uplink transmissions in each UE group or the number of UEs in each UE group. Specifically, when the base station 3 allocates radio resources within one transmission period to a plurality of UE groups, it may preferentially allocate radio resources to a UE group having a relatively small number of uplink transmissions. That is, the priority level is defined so as to change inversely to the number of UEs or the number of uplink transmissions in a UE group.

The frequency-domain scheduling in which a priority level based on the number of uplink transmissions of each UE group is taken into consideration is especially effective when a radio communication technology that involves a continuity (or adjacency) constraint in radio resource allocation is used for the uplink. For example, in SC-FDMA used for an LTE uplink, all resource blocks (RBs) to be allocated to each UE have to be adjacent to each other. Such a continuity (or adjacency) constraint complicates uplink scheduling and causes a decrease in resource utilization efficiency due to fragmentation of uplink radio resources.

According to the frequency-domain scheduling in which a priority level based on the number of uplink transmissions of each UE group is taken into consideration, since radio resources within a transmission period are preferentially allocated to a UE group with a relatively small number of uplink transmissions, it is less likely to be affected by fragmentation of resources. Meanwhile, since a UE group with a relatively large number of uplink transmissions is positioned at a latter part in the resource allocation order, it is susceptible to fragmentation of resources. However, since a plurality of uplink transmissions can be performed by using different fragmented resources, it is robust against fragmentation of resources. Therefore, the frequency-domain scheduling in which a priority level based on the number of uplink transmissions of each UE group is taken into consideration has an advantage that fairness among UE groups can be easily maintained even if fragmentation of radio resources occurs.

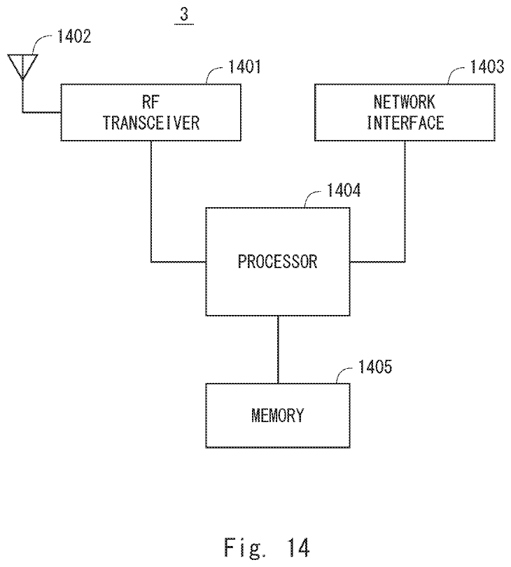

Lastly, configuration examples of the remote UE 1, the relay UE 2, the base station 3, and the UE 4 according to the above-described plurality of embodiments will be described. FIG. 13 is a block diagram showing a configuration example of the remote UE 1. Each of the relay UE 2 and the UE 4 may have a configuration similar to that shown in FIG. 13. A Radio Frequency (RF) transceiver 1301 performs an analog RF signal processing to communicate with the base station 3. The analog RF signal processing performed by the RF transceiver 1301 includes a frequency up-conversion, a frequency down-conversion, and amplification. The RF transceiver 1301 is coupled to an antenna 1302 and a baseband processor 1303. That is, the RF transceiver 1301 receives modulated symbol data (or OFDM symbol data) from the baseband processor 1303, generates a transmission RF signal, and supplies the generated transmission RF signal to the antenna 1302. Further, the RF transceiver 1301 generates a baseband reception signal based on a reception RF signal received by the antenna 1302 and supplies the generated baseband reception signal to the baseband processor 1303.

The RF transceiver 1301 may also be used for sidelink communication with other UEs. The RF transceiver 1301 may include a plurality of transceivers.

The baseband processor 1303 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame), (d) channel coding/decoding, (e) modulation (i.e., symbol mapping)/demodulation, and (f) generation of OFDM symbol data (i.e., baseband OFDM signal) by Inverse Fast Fourier Transform (IFFT). On the other hand, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

For example, in the case of LTE or LTE-Advanced, the digital baseband signal processing performed by the baseband processor 1303 may include signal processing of Packet Data Convergence Protocol (PDCP) layer, Radio Link Control (RLC) layer, MAC layer, and PHY layer. Further, the control-plane processing performed by the baseband processor 1303 may include processing of Non-Access Stratum (NAS) protocol, RRC protocol, and MAC CE.

The baseband processor 1303 may include a modem processor (e.g., Digital Signal Processor (DSP)) that performs the digital baseband signal processing and a protocol stack processor (e.g., Central Processing Unit (CPU) or a Micro Processing Unit (MPU)) that performs the control-plane processing. In this case, the protocol stack processor, which performs the control-plane processing, may be integrated with an application processor 1304 described in the following.

The application processor 1304 may also be referred to as a CPU, an MPU, a microprocessor, or a processor core. The application processor 1304 may include a plurality of processors (processor cores). The application processor 1304 loads a system software program (Operating System (OS)) and various application programs (e.g., voice call application, WEB browser, mailer, camera operation application, and music player application) from a memory 1306 or from another memory (not shown) and executes these programs, thereby providing various functions of the remote UE 1.

In some implementations, as represented by a dashed line (1305) in FIG. 13, the baseband processor 1303 and the application processor 1304 may be integrated on a single chip. In other words, the baseband processor 1303 and the application processor 1304 may be implemented in a single System on Chip (SoC) device 1305. A SoC device may be referred to as a system Large Scale Integration (LSI) or a chipset.

The memory 1306 is a volatile memory, a nonvolatile memory, or a combination thereof. The memory 1306 may include a plurality of memory devices that are physically independent from each other. The volatile memory is, for example, a Static Random Access Memory (SRAM), a Dynamic RAM (DRAM), or a combination thereof. The non-volatile memory is, for example, a mask Read Only Memory (MROM), an Electrically Erasable Programmable ROM (EEPROM), a flash memory, a hard disc drive, or any combination thereof. The memory 1306 may include, for example, an external memory device that can be accessed by the baseband processor 1303, the application processor 1304, and the SoC 1305. The memory 1306 may include an internal memory device that is integrated in the baseband processor 1303, the application processor 1304, or the SoC 1305. Further, the memory 1306 may include a memory in a Universal Integrated Circuit Card (UICC).

The memory 1306 may store software modules (computer programs) including instructions and data to perform processing by the remote UE 1 described in the aforementioned plurality of embodiments. In some implementations, the baseband processor 1303 or the application processor 1304 may be configured to load these software modules from the memory 1306 and execute the loaded software modules, thereby performing the processing of the remote UE 1 described in the above embodiments with reference to the drawings.

FIG. 14 is a block diagram showing a configuration example of the base station 3 according to the above-described embodiment. As shown in FIG. 14, the base station 3 includes an RF transceiver 1401, a network interface 1403, a processor 1404, and a memory 1405. The RF transceiver 1401 performs analog RF signal processing to communicate with the remote UE 1 and the relay UE 2. The RF transceiver 1401 may include a plurality of transceivers. The RF transceiver 1401 is connected to an antenna 1402 and the processor 1404. The RF transceiver 1401 receives modulated symbol data (or OFDM symbol data) from the processor 1404, generates a transmission RF signal, and supplies the generated transmission RF signal to the antenna 1402. Further, the RF transceiver 1401 generates a baseband reception signal based on a reception RF signal received by the antenna 1402 and supplies this signal to the processor 1404.

The network interface 1403 is used to communicate with a network node (e.g., Mobility Management Entity (MME) and Serving Gateway (S-GW)). The network interface 1403 may include, for example, a network interface card (NIC) conforming to the IEEE 802.3 series.

The processor 1404 performs digital baseband signal processing (data-plane processing) and control-plane processing for radio communication. For example, in the case of LTE or LTE-Advanced, the digital baseband signal processing performed by the processor 1404 may include signal processing of the PDCP layer, RLC layer, MAC layer, and PHY layer. Further, the control-plane processing performed by the processor 1404 may include processing of Si protocol, RRC protocol, and MAC CE.

The processor 1404 may include a plurality of processors. For example, the processor 1404 may include a modem-processor (e.g., DSP) that performs the digital baseband signal processing, and a protocol-stack-processor (e.g., CPU or MPU) that performs the control-plane processing.

The memory 1405 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1405 may include a storage located apart from the processor 1404. In this case, the processor 1404 may access the memory 1405 through the network interface 1403 or an I/O interface (not shown).

The memory 1405 may store software modules (computer programs) including instructions and data to perform processing by the base station 3 described in the aforementioned plurality of embodiments. In some implementations, the processor 1404 may be configured to load these software modules from the memory 1405 and execute the loaded software modules, thereby performing the processing of the base station 3 described in the above embodiments with reference to the drawings.

As described above with reference to FIGS. 13 and 14, each of the processors included in the remote UE 1, the relay UE 2, the base station 3, and the UE 4 in the above embodiments executes one or more programs including a set of instructions to cause a computer to perform an algorithm described above with reference to the drawings. These programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). These programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line.

### OTHER EMBODIMENTS

Each of the above embodiments may be used individually, or two or more of the embodiments may be appropriately combined with one another.

Processes and operations, including the uplink scheduling, performed by the base station 3 described in the above-described embodiments may be provided by a Digital Unit (DU) included in a Cloud Radio Access Network (C-RAN) architecture or a combination of the DU and a Radio Unit (RU). The DU is also called a Baseband Unit (BBU). The RU is also called a Remote Radio Head (RRH) or Remote Radio Equipment (RRE). That is, the processes and operations performed by the base station 3 described in the above-described embodiments may be provided by one or more radio stations (i.e., RAN nodes).

Further, the above-described embodiments are merely examples of applications of the technical ideas obtained by the inventors. These technical ideas are not limited to the above-described embodiments and various modifications can be made thereto.

For example, the whole or part of the embodiments disclosed above can be described as, but not limited to, the following supplementary notes.

### (Supplementary Note 1)

An apparatus for uplink scheduling, the apparatus comprising:

a memory; and

at least one processor coupled to the memory, wherein

the at least one processor is configured to distinguish a plurality of uplink transmissions related to a transfer of data originating from a first radio terminal from other uplink transmissions, and

is configured to determine allocation of uplink radio resources at least partly based on whether the plurality of uplink transmissions can be scheduled in the same transmission period,

the plurality of uplink transmissions are transmissions from a plurality of radio terminals including at least one relay terminal to a base station, and

each relay terminal relays traffic between the first radio terminal and the base station through a device-to-device (D2D) link between the relay terminal and the first radio terminal and a backhaul link between the relay terminal and the base station.

### (Supplementary Note 2)

The apparatus described in Supplementary note 1, wherein the plurality of radio terminals include the first radio terminal.

### (Supplementary Note 3)

The apparatus described in Supplementary note 1 or 2, wherein the at least one processor is configured to determine the allocation of uplink radio resources in a manner such that the plurality of uplink transmissions are simultaneously performed in the same transmission period as much as possible.

### (Supplementary Note 4)

The apparatus described in Supplementary note 1 or 2, wherein the at least one processor is configured to preferentially schedule the plurality of uplink transmissions in the same transmission period.

### (Supplementary Note 5)

The apparatus described in any one of Supplementary notes 1 to 4, wherein the at least one processor is configured to determine allocation of radio resources within the same transmission period to the plurality of uplink transmissions in a manner such that a sum of bandwidths or throughputs of the plurality of uplink transmissions is maximized.

### (Supplementary Note 6)

The apparatus described in any one of Supplementary notes 1 to 5, wherein the at least one processor is configured not to consider fairness of resource allocation among the plurality of uplink transmissions.

### (Supplementary Note 7)

The apparatus described in any one of Supplementary notes 1 to 6, wherein the at least one processor is configured to:
distinguish a first group including the plurality of uplink transmissions related to the transfer of the data originating from the first radio terminal from a second group including one or more uplink transmissions related to a transfer of data originating from a second radio terminal; and
determine, according to a predetermined policy, whether to preferentially schedule the first group in a specific transmission period over the second group.

### (Supplementary Note 8)

The apparatus described in Supplementary note 7, wherein the predetermined policy includes, when allocating uplink radio resources, prioritizing one of the first and second groups that includes a smaller number of uplink transmissions or a smaller number of radio terminals.

### (Supplementary Note 9)

The apparatus described in Supplementary note 7 or 8, wherein the predetermined policy includes considering fairness of radio resource allocation between the first and second groups.

### (Supplementary Note 10)

The apparatus described in any one of Supplementary notes 7 to 8, wherein the at least one processor is configured to, when allocating uplink radio resources within the specific transmission period, determine whether to prioritize the first group over the second group at least partly based on the number of uplink transmissions in each group or the number of radio terminals in each group.

### (Supplementary Note 11)

The apparatus described in any one of Supplementary notes 1 to 10, wherein the transmission period includes a subframe.

### (Supplementary Note 12)

The apparatus described in any one of Supplementary notes 1 to 11, wherein the at least one processor is configured to detect the plurality of radio terminals based on first control information that is transmitted from the first radio terminal and contains an identifier of the at least one relay terminal.

### (Supplementary Note 13)

The apparatus described in Supplementary note 12, wherein the first control information includes an SL-DestinationlnfoListUC information element in a Sidelink UE information message.

### (Supplementary Note 14)

The apparatus described in Supplementary note 12, wherein the first control information includes a Destination Index field in a Sidelink Buffer Status Report MAC Control Element.

### (Supplementary Note 15)

The apparatus described in any one of Supplementary notes 1 to 11, wherein the at least one processor is configured to detect the plurality of radio terminals based on second control information that is transmitted from each of the at least one relay terminal and contains an identifier of the first radio terminal connected to each relay terminal.

### (Supplementary Note 16)

The apparatus described in any one of Supplementary notes 1 to 11, wherein the at least one processor is configured to detect the plurality of radio terminals based on third control information that is transmitted from each of the plurality of radio terminals and contains a group identifier indicating that the plurality of radio terminals are associated with the first radio terminal.

### (Supplementary Note 17)

The apparatus described in any one of Supplementary notes 1 to 16, wherein each of the plurality of uplink transmissions is an uplink logical channel or an uplink bearer.

### (Supplementary Note 18)

A method for uplink scheduling, the method comprising:

distinguishing a plurality of uplink transmissions related to a transfer of data originating from a first radio terminal from other uplink transmissions, and

determining allocation of uplink radio resources at least partly based on whether the plurality of uplink transmissions can be scheduled in the same transmission period, wherein the plurality of uplink transmissions are transmissions from a plurality of radio terminals including at least one relay terminal to a base station, and

each relay terminal relays traffic between the first radio terminal and the base station through a device-to-device (D2D) link between the relay terminal and the first radio terminal and a backhaul link between the relay terminal and the base station.

### (Supplementary Note 19)

The method described in Supplementary note 18, wherein the determining comprises determining the allocation of uplink radio resources in a manner such that the plurality of uplink transmissions are simultaneously performed in the same transmission period as much as possible.

### (Supplementary Note 20)

The method described in Supplementary note 18, wherein the determining comprises preferentially scheduling the plurality of uplink transmissions in the same transmission period.

### (Supplementary Note 21)

The method described in any one of Supplementary notes 18 to 20, wherein the determining comprises determining allocation of radio resources within the same transmission period to the plurality of uplink transmissions in a manner such that a sum of bandwidths or throughputs of the plurality of uplink transmissions is maximized.

### (Supplementary Note 22)

The method described in any one of Supplementary notes 18 to 21, wherein the determining comprises not considering fairness of resource allocation among the plurality of uplink transmissions.

### (Supplementary Note 23)

The method described in any one of Supplementary notes 18 to 22, wherein

the distinguishing comprises distinguishing a first group including the plurality of uplink transmissions related to the transfer of the data originating from the first radio terminal from a second group including one or more uplink transmissions related to a transfer of data originating from a second radio terminal, and

the method further comprises determining, according to a predetermined policy, whether to preferentially schedule the first group in a specific transmission period over the second group.

### (Supplementary Note 24)

The method described in Supplementary note 23, wherein the predetermined policy includes, when allocating uplink radio resources, prioritizing one of the first and second groups that includes a smaller number of uplink transmissions or a smaller number of radio terminals.

### (Supplementary Note 25)

The method described in Supplementary note 23 or 24, wherein the predetermined policy includes considering fairness of radio resource allocation between the first and second groups.

### (Supplementary Note 26)

The method described in any one of Supplementary notes 23 to 25, further comprising, when allocating uplink radio resources within the specific transmission period, determining whether to prioritize the first group over the second group at least partly based on the number of uplink transmissions in each group or the number of radio terminals in each group.

### (Supplementary Note 27)

A program for causing a computer to perform a method described in any one of Supplementary notes 18 to 26.

This application is based upon and claims the benefit of priority from Japanese patent application No. 2016-058489, filed on Mar. 23, 2016, the disclosure of which is incorporated herein in its entirety by reference.

### REFERENCE SIGNS LIST

1 REMOTE UE
2 RELAY UE
3 BASE STATION
4 UE
201 UPLINK SCHEDULER
1301 RADIO FREQUENCY (RF) TRANSCEIVER
1303 BASEBAND PROCESSOR
1304 APPLICATION PROCESSOR
1306 MEMORY
1404 PROCESSOR
1405 MEMORY

1. An apparatus for uplink scheduling, the apparatus comprising:
a memory; and
at least one processor coupled to the memory and configured to:
distinguish a plurality of uplink transmissions related to a transfer of data originating from a first radio terminal from other uplink transmissions; and
determine allocation of uplink radio resources at least partly based on whether the plurality of uplink transmissions can be scheduled in the same transmission period, wherein
the plurality of uplink transmissions are transmissions from a plurality of radio terminals including at least one relay terminal to a base station, and
each relay terminal relays traffic between the first radio terminal and the base station through a device-to-device (D2D) link between the relay terminal and the first radio terminal and a backhaul link between the relay terminal and the base station.

2. The apparatus according to claim 1, wherein the plurality of radio terminals include the first radio terminal.

3. The apparatus according to claim 1, wherein the at least one processor is configured to determine the allocation of uplink radio resources in a manner such that the plurality of uplink transmissions are simultaneously performed in the same transmission period as much as possible.

4. The apparatus according to claim 1, wherein the at least one processor is configured to preferentially schedule the plurality of uplink transmissions in the same transmission period.

5. The apparatus according to claim 1, wherein the at least one processor is configured to determine allocation of radio resources within the same transmission period to the plurality of uplink transmissions in a manner such that a sum of bandwidths or throughputs of the plurality of uplink transmissions is maximized.

6. The apparatus according to claim 1, wherein the at least one processor is configured not to consider fairness of resource allocation among the plurality of uplink transmissions.

7. The apparatus according to claim 1, wherein the at least one processor is configured to:
distinguish a first group including the plurality of uplink transmissions related to the transfer of the data originating from the first radio terminal from a second group including one or more uplink transmissions related to a transfer of data originating from a second radio terminal; and
determine, according to a predetermined policy, whether to preferentially schedule the first group in a specific transmission period over the second group.

8. The apparatus according to claim 7, wherein the predetermined policy includes, when allocating uplink radio resources, prioritizing one of the first and second groups that includes a smaller number of uplink transmissions or a smaller number of radio terminals.

9. The apparatus according to claim 7, wherein the predetermined policy includes considering fairness of radio resource allocation between the first and second groups.

10. The apparatus according to claim 7, wherein the at least one processor is configured to, when allocating uplink radio resources within the specific transmission period, determine whether to prioritize the first group over the second group at least partly based on the number of uplink transmissions in each group or the number of radio terminals in each group.

11. The apparatus according to claim 1, wherein the transmission period includes a subframe.

12. The apparatus according to claim 1, wherein the at least one processor is configured to detect the plurality of radio terminals based on first control information that is transmitted from the first radio terminal and contains an identifier of the at least one relay terminal.

13. The apparatus according to claim 12, wherein the first control information includes an SL-DestinationlnfoListUC information element in a Sidelink UE information message.

14. The apparatus according to claim 12, wherein the first control information includes a Destination Index field in a Sidelink Buffer Status Report MAC Control Element.

15. The apparatus according to claim 1, wherein the at least one processor is configured to detect the plurality of radio terminals based on second control information that is transmitted from each of the at least one relay terminal and contains an identifier of the first radio terminal connected to each relay terminal.

16. The apparatus according to claim 1, wherein the at least one processor is configured to detect the plurality of radio terminals based on third control information that is transmitted from each of the plurality of radio terminals and contains a group identifier indicating that the plurality of radio terminals are associated with the first radio terminal.

17. The apparatus according to claim 1, wherein each of the plurality of uplink transmissions is an uplink logical channel or an uplink bearer.

18. A method for uplink scheduling, the method comprising:
distinguishing a plurality of uplink transmissions related to a transfer of data originating from a first radio terminal from other uplink transmissions, and
determining allocation of uplink radio resources at least partly based on whether the plurality of uplink transmissions can be scheduled in the same transmission period, wherein
the plurality of uplink transmissions are transmissions from a plurality of radio terminals including at least one relay terminal to a base station, and
each relay terminal relays traffic between the first radio terminal and the base station through a device-to-device (D2D) link between the relay terminal and the first radio terminal and a backhaul link between the relay terminal and the base station.

19. The method according to claim 18, wherein the determining comprises determining the allocation of uplink radio resources in a manner such that the plurality of uplink transmissions are simultaneously performed in the same transmission period as much as possible.

20. The method according to claim 18, wherein the determining comprises preferentially scheduling the plurality of uplink transmissions in the same transmission period.

21.-27. (canceled)
